(19) United States
(12) Patent Application Publication
(10) Pub. No.: US 2016/0165846 A1
(43) Pub. Date: Jun. 16, 2016

(54) APPARATUS AND METHOD FOR CANINE CONDITIONING

(71) Applicants: Daniel Joseph Emmi, Winston-Salem, NC (US); Theresa Mary Emmi, Winston-Salem, NC (US)

(72) Inventors: Daniel Joseph Emmi, Winston-Salem, NC (US); Theresa Mary Emmi, Winston-Salem, NC (US)

(21) Appl. No.: 14/965,331

(22) Filed: Dec. 10, 2015

Related U.S. Application Data
(60) Provisional application No. 62/089,936, filed on Dec. 10, 2014.

(51) Int. Cl. A01K 15/02

(52) U.S. Cl. CPC A01K 15/027

(57) ABSTRACT

An apparatus and method to hold and stabilize canine conditioning balls. This apparatus is independent of the trainer, and secures the ball to the support. Use of multiple balls and holders is possible and supports a wide variety of canine conditioning exercises.

### CROSS-REFERENCE TO RELATED APPLICATION

This application claims the benefit of priority of U.S. provisional application No. 62/089,936, filed Dec. 10, 2014, the contents of which are herein incorporated by reference.

### BACKGROUND OF THE INVENTION

The present invention relates to canine conditioning and, more particularly, to a system and method for canine body conditioning with fitness balls.

Oblong, peanut or egg shaped canine fitness balls in the art need to be stable for the dog to properly get up on them to exercise. Manually holding the ball limits the trainer's ability to work with the dog on the ball and also the types of exercises that can be done. Wedging the ball against furniture limits the dog's access to the ball.

The makers of canine peanut balls currently suggest positioning the ball between ones knees or putting it against an immovable object like a sofa. The trainer is responsible for stabilizing the ball and can really only handle one ball. Similarly, manual techniques make it virtually impossible to employ more than one ball in a canine exercise routine. The problems with current practices are: unstable support for the exercise ball; trainer focus on the ball rather than the dog; limited types of exercises available; and an inability to easily use multiple balls at a time.

As can be seen, there is a need for an apparatus and method for stabilizing canine fitness balls for body conditioning and training to provide mobility to the trainer and secures the ball to the support. Use of multiple balls and holders is possible and supports a wide variety of exercises.

### SUMMARY OF THE INVENTION

In one aspect of the present invention, an apparatus for canine conditioning exercises, comprises a plurality of longitudinal frame members disposed in a spaced apart relation relative to one another; a plurality of upright frame members attached to and extending substantially vertically from the longitudinal frame members; and a transverse frame member interconnecting the longitudinal frame members. The apparatus is adapted to receive an elongate exercise ball between the plurality of upright frame members.

In some embodiments, a first pair of laterally opposed upright frame members are adjustably attached along a longitudinal length of the longitudinal frame members. A second pair of laterally opposed upright frame members may be attached in a fixed position to the longitudinal frame members. The first pair of upright frame members may be adjustable via a slot defined along a portion of the longitudinal frame member, a sleeve defined at a lower end of the laterally opposed upright frame members; and a fastener, captively received in the slot, and operable with a knob, to clamp the sleeve to the longitudinal frame member.

In some aspects of the invention the apparatus may also include a strap extending substantially around a circumference of the elongate exercise ball and the transverse frame member. An adjustable buckle may be attached to the strap, wherein the length of the strap is adjustable around the ball and the transverse frame member.

Other aspects of the invention include a method of training canine fitness, comprising: providing a canine conditioning ball stabilization frame, comprising: a plurality of longitudinal frame members disposed in a spaced apart relation relative to one another; a plurality of upright frame members attached to and extending vertically from the longitudinal frame members; and a transverse frame member interconnecting the longitudinal frame members. The method may include securing a canine exercise ball between the upright frame members; and training the canine to mount the exercise ball. According to other aspects of the invention, the method may also include providing a plurality of canine conditioning ball stabilization frames; securing a canine exercise ball in each of the stabilization frames; and training the canine to mount a first exercise ball and a second exercise ball. The method may also include strapping the exercise ball to the stabilization frame.

These and other features, aspects and advantages of the present invention will become better understood with reference to the following drawings, description and claims.

### BRIEF DESCRIPTION OF THE DRAWINGS

FIG. 1 is a perspective view of the invention shown in exemplary usage.

FIG. 2 is a bottom perspective view of the invention shown in use.

FIG. 3 is a top perspective view of the invention shown in use.

FIG. 4 is a perspective view of the invention.

FIG. 5 is a detail perspective view of the invention demonstrating adjustability.

FIG. 6 is a section detail view of the invention taken along line 6-6 in FIG. 5 demonstrated in locked configuration.

FIG. 7 is a section detail view of the invention demonstrated in unlocked configuration.

FIG. 8 is a detail section view of the invention taken along line 8-8 in FIG. 4.

FIG. 9 is a detail section view of the invention taken along line 9-9 in FIG. 4.

FIG. 10 is a section detail view of the invention taken along line 10-10 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

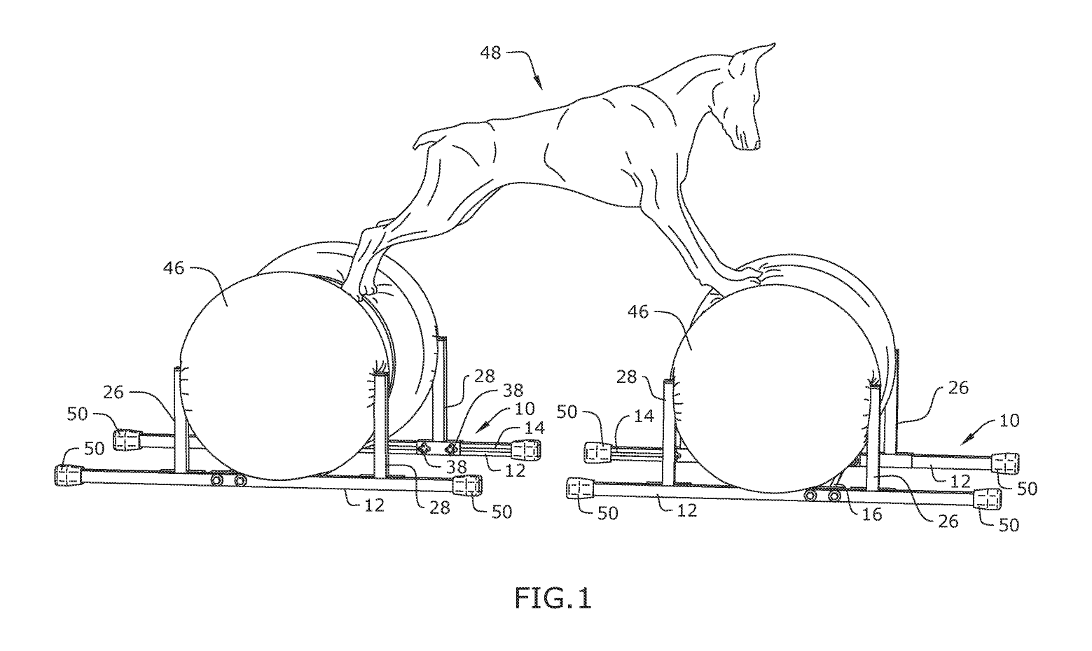

Broadly, an embodiment of the present invention provides a frame to hold an oblong, peanut, or egg shaped canine fitness ball in order to stabilize the ball for the dog to perform conditioning exercises. The apparatus and method of the present invention independently holds the ball in a stable position allowing access from any direction. The trainer can then work with the dog independently without having to manage the ball. In addition, multiple balls and holders can be positioned in a variety of ways to give the dog a complete body work out, as best seen in reference to FIG. 1. The canine conditioning ball stabilization frame 10 is adapted to receive and stabilize a canine conditioning ball 46 between a plurality of upstanding frame members 26 & 28, so as to permit a canine 48 to mount the ball 46 and perform a variety of conditioning exercises.

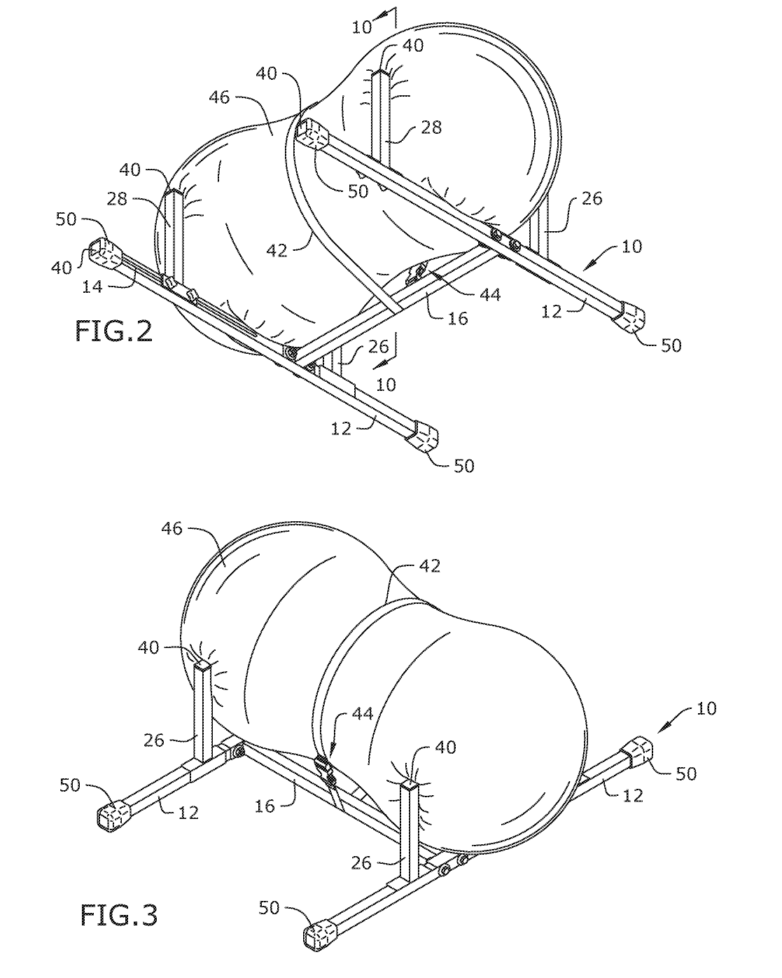

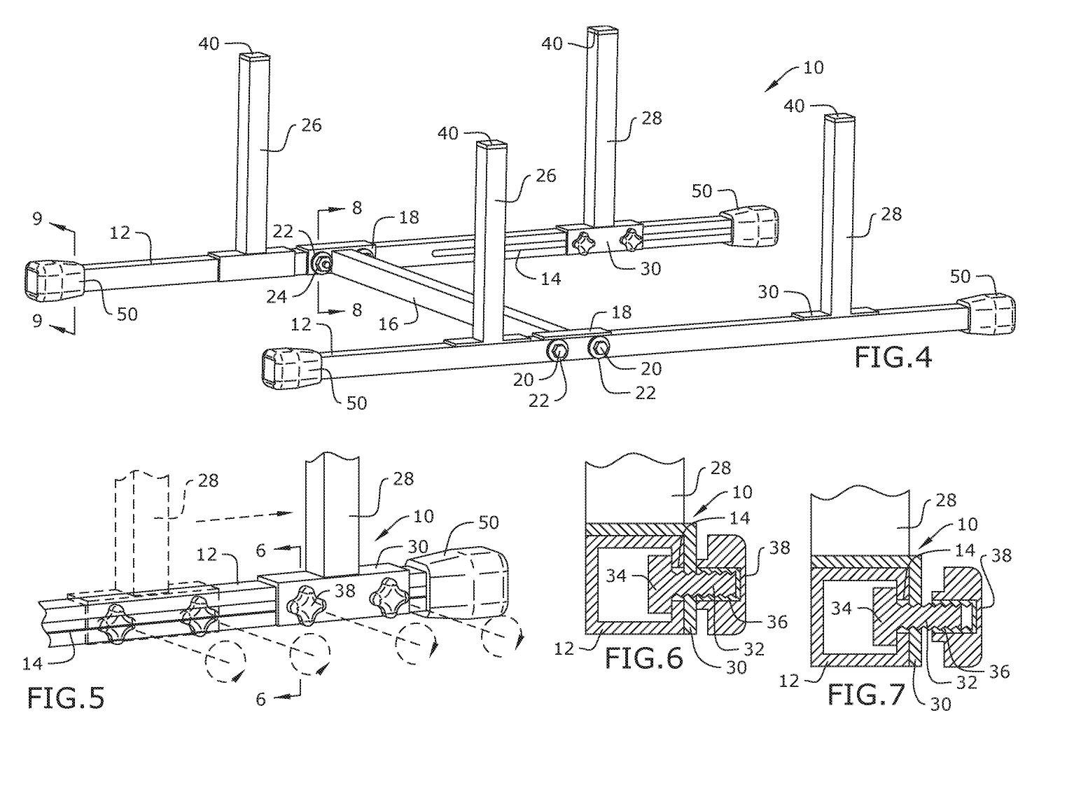

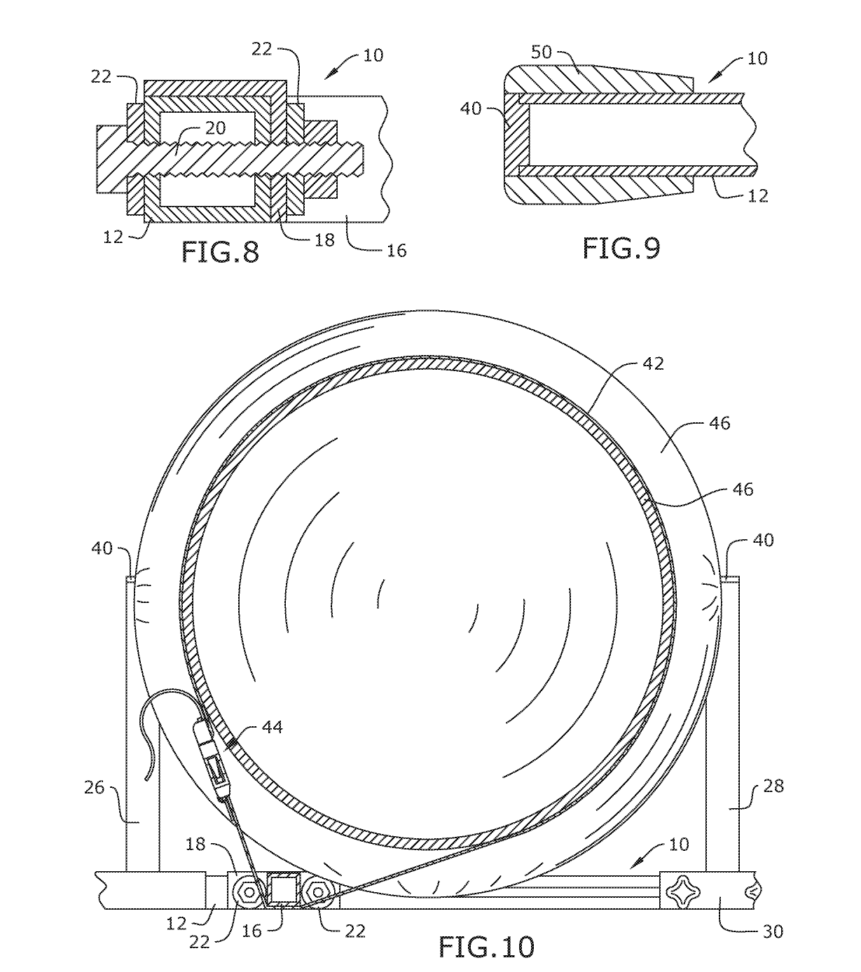

As seen in reference FIGS. 2-4 the stabilization frame 10, comprises a plurality of elongate horizontally disposed longitudinal frame members 12. The longitudinal frame members 12 may be disposed in a generally parallel configuration to provide a base for the stabilization frame 10. A transverse frame element 16 may be disposed to interconnect and brace the longitudinal frame members 12. The transverse frame element 16 may be permanently secured to the longitudinal frame members 12, via a weld. In a preferred embodiment, the transverse frame element 16 may be remove ably attached to the longitudinal frame members via a fastener, such as bolts, screws, latches or pins 20, 22. For added stability, transverse frame element 16 may also include a brace flange 18 to prevent torsional movement of the frame members. The brace flange 18 may be secured via fasteners, such as a bolt 20, a washer 22, and a nut 24, such as depicted in reference to FIG. 8.

A plurality of upstanding frame members 26 may be attached to the longitudinal frame members 12, generally parallel and spaced apart to define a cradle for retaining the conditioning ball 46. The upstanding frame members 26 are preferably about (but not necessarily) 4 to 18 inches in length, more preferably about 10 inches in length. In a preferred embodiment, the upstanding frame members 26 may be adjustably secured to the longitudinal frame members 12.

The longitudinal frame members 12 may be formed with an adjustment slot, or a rail 14 defined along a longitudinal length of the frame member 12. The upright frame member 28 may then be adjustably secured along the rail 14 via a fastener, such as bolts, screws, thumb screws, handled bolts, and the like. In a preferred embodiment, a first pair of transversely opposed upright frame members 28 may be adjustable, while a second pair of transversely opposed upright frame members 26 may be attached in a fixed relationship to the longitudinal frame members 28.

Alternatively, as best seen in reference to FIG. 5 a lower end of the upright frame 26 may be defined with a sleeve 30 that may partially or substantially surround the longitudinal frame member 28, such that the sleeve may slidably adjust along the longitudinal frame member 28. Once positioned, the adjustable upright frame members 26 may be secured via fastener, such as a threaded knob fastener, or a pin 38. As seen in reference to FIGS. 6 and 7, in a preferred embodiment, a bolt 34 may be captively retained within the slot 14 with the threads 32 extending through the slot 14 and an aperture defined in the sleeve 30. The knob 38 has corresponding threads 36 so that when it is tightened, it clamps the sleeve 30 against the longitudinal frame member 12.

The stabilization frame 10 is preferably (but not necessarily) about 2 to 4 feet in length, more preferably about 3 foot long. The frame 10 and its structural members may be constructed of any suitable rigid material and may include metal, wood and plastics. The frame elements may be formed of any shape materials including but not limited to square, rectangular, round, triangular.

The ends of the longitudinal frame members 12 may be provided with an anti-skid element 50, such as an end cap, shown in FIG. 9, which may be comprised of a material that may include but is not limited to rubber plastic or metal. Similarly the ends of the upright frame members 26 & 28 may be provisioned with protective endcaps 40.

While the upright frame members 26 & 28 may be adequate to secure the exercise ball 46 within the frame 10, during particularly rigorous exercises, the exercise ball 46 may bounce within the frame 10. To provide added retention and security for the ball 46, a strap 42 may be applied around a circumferential aspect of the exercise ball 46 and the transverse frame member 16. The strap 42 may be adjustably secured via a buckle 44, as seen in reference to FIGS. 2, 3 & 10.

A method of use for the canine conditioning ball stabilization frame 10 includes providing at least one stabilization frame 10. Placing an exercise ball 46 between upright frame members 26 & 28. Optionally securing the exercise ball 46 to the frame 10 with a strap 42. Directing the canine 48 to mount the exercise ball 46 to perform conditioning exercises. The method may include providing a plurality of stabilization frames 10 with exercise balls 46 in a spaced apart relation and having the canine perform conditioning exercises on one or more of the exercise balls 46.

It should be understood, of course, that the foregoing relates to exemplary embodiments of the invention and that modifications may be made without departing from the spirit and scope of the invention as set forth in the following claims.

What is claimed is:

1. An apparatus for canine conditioning exercises, comprising:
a plurality of longitudinal frame members disposed in a spaced apart relation relative to one another;
a plurality of upright frame members attached to and extending substantially vertically from the longitudinal frame members; and
a transverse frame member interconnecting the longitudinal frame members.

2. The apparatus of claim 1, further comprising;
an elongate exercise ball received between the plurality of upright frame members.

3. The apparatus of claim 1, wherein a first pair of laterally opposed upright frame members are adjustably attached along a longitudinal length of the longitudinal frame members.

4. The apparatus of claim 2, wherein a second pair of laterally opposed upright frame members are attached in a fixed position to the longitudinal frame members.

5. The apparatus of claim 3, further comprising:
a slot defined along a portion of the longitudinal frame member;
a sleeve defined at a lower end of the laterally opposed upright frame members; and
a fastener, captively received in the slot, and operable with a knob, to clamp the sleeve to the longitudinal frame member.

6. The apparatus of claim 2, further comprising:
a strap extending substantially around a circumference of the elongate exercise ball and the transverse frame member.

7. The apparatus of claim 6, further comprising:
an adjustable buckle attached to the strap, wherein the length of the strap is adjustable around the ball and the transverse frame member.

8. A method of training canine fitness, comprising:
providing a canine conditioning ball stabilization frame, comprising:
a plurality of longitudinal frame members disposed in a spaced apart relation relative to one another;
a plurality of upright frame members attached to and extending vertically from the longitudinal frame members;
a transverse frame member interconnecting the longitudinal frame members.
securing a canine exercise ball between the upright frame members;
training the canine to mount the exercise ball.

9. The method of claim 8, further comprising:
providing a plurality of canine conditioning ball stabilization frames;
securing a canine exercise ball in each of the stabilization frames;
training the canine to mount a first exercise ball and a second exercise ball.

10. The method of claim 8, further comprising:
strapping the exercise ball to the stabilization frame.
